(19) United States
(12) Patent Application Publication
(10) Pub. No.: US 2012/0036091 A1
(43) Pub. Date: Feb. 9, 2012

(54) SYSTEM AND METHOD FOR AUTOMATED, RANGE-BASED IRRIGATION

(76) Inventor: Kenneth W. Cook, Athens, TX (US)

(21) Appl. No.: 12/717,621

(22) Filed: Mar. 4, 2010

Related U.S. Application Data
(62) Division of application No. 12/506,614, filed on Jul. 21, 2009, now abandoned.
Application No. 12/506,614 is a continuation-in-part of application No. 11/451,037, filed on Jun. 12, 2006, now abandoned.

(51) Int. Cl. G06Q 30/02

(52) U.S. Cl. 705/412

(57) ABSTRACT

A centralized irrigation system provides non-decision-making controllers in combination with a client server architecture that employs irrigation algorithms for monitoring and control. Live feedback means send information back to a server for use with sophisticated modeling capabilities to monitor exceptions to a planned control scheme, adjust control parameters, and provide a real-time update to system performance. This feedback is instantaneously routed from the server to monitoring and feedback client software connected to the server through a network and enables volume-based cycles and soaks of irrigation. Range-based control strategies determine a total volumetric water-holding capacity for a volume of soil and a range of desirable soil moisture. The system permits a shared-savings business model where the vendor provides a system and the customer only pays the vendor a portion of the savings obtained by using the system. It further permits rapidly deploying improved control systems to save water for a community.

### RELATED APPLICATIONS

This is a Divisional application of U.S. patent application Ser. No. 12/506,614 which is a Continuation-in-part application of U.S. application Ser. No. 11/451,037 filed on Jun. 2, 2006.

### FIELD OF THE INVENTION

The present invention relates generally to the field of the computerized monitoring and control of irrigation, and more particularly to a system and method that provide range-based irrigation using non-decision-making controllers in combination with a client server architecture that uses enhanced modeling for monitoring, analysis, and control.

### BACKGROUND OF THE INVENTION

Water management through the computerized monitoring and control of irrigation is of increasing importance. The cost of water continues to rise because of its growing scarcity and the heightened demands for its use. For example, there is upward trend in commercial water rates in many of the major southern and western U.S. urban markets. Because of political considerations, water for commercial irrigation is often billed at higher rates than water for residential use, making the commercial landscape maintenance business more and more expensive.

### Prior Centralized Irrigation Systems

To reduce the cost of water used for commercial irrigation, automated, centralized systems have been created to regulate the amount of water used to irrigate specific areas. These systems rely on automated machine-to-machine (“M2M”) technology, as most irrigation is typically scheduled during night-time hours when no maintenance staff is present on a property to respond to identifiable irrigation system problems. Even if irrigation was done during daylight hours, labor rates and property complexities would never allow human oversight to be a feasible approach for pursuing irrigation best practices management.

However, these systems have many disadvantages, as described below. In general, their use leads to the over-watering that can be seen at most commercial sites today.

### Clock-Based Irrigation Systems

Centralized irrigation systems that use clocks alone to regulate watering schedules for specific areas typically represent the full extent of irrigation management tools employed at commercial properties across America today. FIG. 1 illustrates a typical clock-based irrigation system for an area such as site 1 202. A clock-based regulator 302 electronically controls valve 1 342 for hydrozone site 1 222 and valve 2 344 for hydrozone site 2 224. For example, clock-based regulator 302 can be set to open valve 1 342 for a specified period of time to irrigate hydrozone site 1 222 and to open valve 2 344 for a different period of time to irrigate hydrozone site 2 224. Such a system may also comprise a radio receiver 304 that can receive ET (evapotranspiration) information applicable to site 1 202 from a radio transmitter 306, for example from a weather satellite or weather station, so that clock-based regulator 302 can use the ET to adjust irrigation times. ET is an agronomic measure in inches of the amount of moisture lost through evaporation and plant consumption, of an industry accepted plant type.

In addition, such a system may employ one or more rain sensors 1 362 that can shut off irrigation a predetermined time, to reduce overwatering.

These systems have no automated capability for regulation according to other, changing variables than watering time, such as current rainfall in the area, and lack even a remote on/off capability. They are simply turned on for specific amounts of time according to a predetermined estimate of an area's need for water.

Clock-based irrigation systems have major disadvantages. Since water pressure is typically not constant through water pipes and these systems do not take flow readings to determine a pipe's actual output, they cannot accurately determine how much water they are really applying to an area, which is potentially wasteful. They have no way of automatically monitoring the state of repair of their equipment in the field. Moreover, although these systems may have rain sensors 362 that can shut off the controllers for a predetermined time, they typically do not recalculate the irrigation time for the following day based on such changes. As a result of these factors, these systems tend to result in over-watering, for example during rainstorms.

Consistent over-watering is damaging to plants, turf, and surrounding hardscapes such as patios, walls, and walkways and is economically wasteful. It can result in
Premature plant and turf death resulting from excessive moisture related diseases;
Unnecessary hardscape deterioration caused by standing water delivered by the irrigation system or ice that develops as a result;
Tenant liability claims at commercial sites, resulting from standing water delivered by the irrigation system or ice that develops as a result of untimely irrigation on property hardscapes; and
Loss of potential tenants and leasing prospects due to sub-par landscape cosmetics.

### Smart-Controller-Based Scheduling Systems for Irrigation

More advanced centralized irrigation systems, including Web-based systems, use networked smart controllers or related components to schedule irrigation at remote sites, rather than relying on timed schedules alone. Instead, they schedule irrigation based on basic zone factors stored in the smart controller and updated macroclimate factors such as predicted ET. Site factors have to do with characteristics that can influence the need for irrigation, such as plant type, soil type, proximity to heat-absorbing asphalt parking areas, and exposure to prevailing winds.

FIG. 2 shows a typical smart controller-based system, where a server 100 is set up with a Web portal page 402 with an interface 404 and database 406. The server 100 may communicate with other devices over a network, such as wireless pager network 130. For example, computer device 1 110 and computer device 2 120 can communicate with server 100 through Web portal page 402 and interface 404 to input data that is stored in database 406 and to control irrigation operations. Server 100 also has a weather tracking (WT) feature 412 that it uses to monitor information from networks of weather stations, such as weather station 1 332 and 2 334, and to calculate daily schedule modifications for specific irrigation zones and plant types.

Server 100 sends the ET numbers over pager network 130 to decision-making controllers at irrigation sites, and the controllers in turn apply the basic zone factors to the ET number (in inches), and modify a pre-set schedule, then open and close valves on water pipes to carry out more efficient watering. Such systems can improve water conservation over clock-based systems, because they can automatically regulate irrigation according to recent weather conditions, and they typically reduce over-watering.

For irrigating an area represented by site 1 202, for example, a smart controller 1 312 is provided. Site 1 202 may be further divided into different sub-zones, such as hydrozone 1 222 and hydrozone 2 224, which may represent area with different variables, for example different soil types, plant cover, and slope. To permit specific irrigation according to each hydrozone's needs, hydrozone 1 222 may be provided with water valve 1 342 and rain sensor 1 362 and hydrozone 2 224 with water valve 2 344 and rain sensor 2 364.

Smart controller 1 312 is equipped with algorithm 1 408, which is programmed to calculate water requirements based on data input from elements such as ET data from weather station 1 332 through server 100, data about the presence of rainfall in hydrozone 1 222 from rain sensor 1 362, and data about the presence of rainfall in hydrozone 2 224 from rain sensor 2 364. Based on these calculations, smart controller 1 312 opens or closes valve 1 342 for hydrozone 1 222 and valve 2 344 for hydrozone 2 224.

For irrigating a different area represented by site 2 204, with different sub-zones, such as hydrozone 3 226 and hydrozone 4 228 a separate smart controller 2 314 is provided, equipped with a different algorithm 2 410 designed for the needs of that area. Again, smart controller 2 314 collects through server 100 data from weather station 2 334, and from rain sensors 3 366 and 4 368, calculates appropriate irrigation, and opens or closes valve 3 346 for hydrozone 3 226 and valve 4 348 for hydrozone 4 228.

The Hydropoint WeatherTrak® system as described in US Patent Applications 20050119797, 20050143842, and 20050187666 is an example of such a system.

### Disadvantages of Prior Centralized Irrigation Systems

These systems have serious disadvantages, primarily because they are not sufficiently precise enough in the environmental data they collect and the calculations they make for irrigating specific sites. For example, they typically do not monitor or collect the actual volume of water that was applied to an area from a previously generated schedule—preventing the generation of an accurate new schedule—and therefore, these types of systems can only guess the actual irrigation requirement. In addition, they typically use prior-day ET for their calculations of daily schedule modifications, although weather conditions may change dramatically not only from day to day but from moment to moment.

They also do not typically identify microclimates within zones sufficiently to efficiently modify pre-set schedules for special requirements in the microclimate. There typically is a water window of only so much water capacity per day in a given area, so that in some cases it would be more efficient to irrigate only those zones that have the greatest need based on the microclimate.

Another major problem is that these systems typically attempt to calculate a daily replacement net irrigation requirement for a zone, based on basic site and environmental factors, rather than calculate an optimal range of soil moisture. Plants actually do better within cycles of wetness and dryness in an appropriate range than they do when kept constantly at a single amount. For example, the Water Management Committee of The Irrigation Association has developed, adopted and publicized “Landscape Irrigation Scheduling and Water Management,” March 2005, which acknowledges the best methods of plant irrigation by watering to a management-defined depletion level (MAD).

As a result of these limitations, although these systems may deliver water more effectively to a given zone than clock-based systems do, they are still only focused to a limited degree on reducing water waste and optimizing irrigation water, which typically makes them more expensive to operate than is possible.

Moreover, these products typically have complicated, difficult-to-use interfaces, which makes them often complex to program, update, and manage and difficult to evaluate for return on investment. For example, decision-making controllers that themselves calculate water requirements and regulate irrigation may need to be updated at times. This updating will typically need to be done at the sites rather than at a central location, which is time consuming, laborious, and expensive. Smart controllers may offer an ability to update their firmware remotely; however, because the algorithms for their processes reside in the controllers, the controllers will always be difficult to update easily and efficiently.

In addition, these systems do not typically monitor the actual flow of water at a site. Instead, they irrigate a site based on a calculation of the system's flow rate from a fixed point in time. Flow rates, however, may vary for numerous reasons, including systemic problems and leaks, which these systems typically neither monitor nor take into account.

Fluctuations in flow rate can have very significant effects for irrigation. For example, if a zone is scheduled to receive 1000 gallons of water, and the zone's expected flow rate is 100 gpm (gallons per minute), these systems will typically turn on water to that zone for 10 minutes (10 minutes*100 gpm=1000 ga). However, it is very unlikely that the zone will ever run exactly 100 gpm. Because the actual variations of flow rate are not monitored and used to calculate the next day's water needs for the site, either excess watering or potential plant loss will typically result.

Some of the other limitations of these systems are as follows:
They do not attempt to identify and stop leaks when they occur;
They do not attempt to monitor soil moisture in order to maximize the use of water provided by natural rain events.
Their field hardware is available in only pre-set configurations;
Their firmware is typically not upgradeable, which leads to planned obsolescence;
Because their communications are based on polling technology, they are not real-time.

The server periodically polls the smart controllers for data updates and do not provide steady streams of data;
Central software upgrades to their systems are expensive and most frequently require a consultant to install and restore data;
Their systems are difficult to operate, support services from suppliers are generally lacking, and dedicated internal operations personnel costs are high and can more than nullify any water cost savings:
They do not take flow readings based on the pipe's output, so that they cannot detect changes in water pressure.
They do not collect, and therefore cannot consider, water volume that was applied successfully, or unsuccessfully, from a previous schedule.
Each smart controller must be updated individually for required changed.

Without any leak detection and related automatic shut-down capabilities or soil moisture monitoring capabilities that enable the complete use of water provided by natural rain events, the savings potential from watering strictly to prior-day ET can and likely will be wiped out by one significant line break per year that goes undetected for even a short time. The combination of tenant/customer traffic (pedestrian and vehicular) at commercial sites and high-speed landscaper maintenance techniques virtually ensures that line breaks or other major water wasting system events will occur one or more times each year.

Therefore a need exists for an automated, centralized system that can more finely calculate and regulate the range-based irritation in zone and microclimates, that employs an easier-to-use and more effective interface for monitoring, analyzing, and controlling applications, and that uses a more efficient hardware system.

Such a system can accomplish greater savings in water resources than prior techniques permit, while at the same time ensuring optimum irrigation. The amount of reduction allows use of a business model in which the party providing the system charges customers a percentage of the savings achieved.

### BRIEF SUMMARY OF THE INVENTION

The following explanation describes the present invention by way of example and not by way of limitation.

As mentioned above, irrigation systems have not historically been tightly monitored or controlled despite increasing costs and scarcity of the resources such as irrigation water. The current invention provides the benefits of monitoring without requiring a central control room facility, while implementing control strategies that are more economical and effective.

### Feedback

One aspect of the current invention is the use of non-decision-making controllers in combination with a client server architecture that employs irrigation algorithms for monitoring and control. That architecture typically includes a live feedback means such as flow meters and rain buckets that send information back to a server, so that the feedback means can be used to monitor exceptions to a planned control scheme, to adjust control parameters, and to provide a real-time update to system performance. This feedback enables volume-based cycles and soaks of irrigation that are more effective and economical than prior techniques. This approach has non-obvious and unexpected benefits relative to trends in some industries toward decision-making controllers and distributed control systems.

### Range-Based Control Strategies

Another aspect of the current invention is the use of range-based control strategies that take into account both a minimal allowed soil moisture depletion (typically referred to as MAD), and an allowed maximum amount of moisture (Target) that is less than the total volumetric holding capacity (often referred to as Mhc—Maximum Holding Capacity) for the soil. In the case of irrigation systems which utilize MAD to determine watering needs, a range-based approach typically seeks to fill the soil with moisture to the maximum holding capacity (Mhc) of the soil whereas the approach of the current invention creates significant water savings by allowing for and anticipating future rain events that would otherwise not be utilized. When the soil moisture is replenished to Mhc, any rain that follows the irrigation will run off, whereas if the soil moisture is replenished to a Target level above MAD (to avoid plant health issues) and yet less than Mhc, the difference between the target volume and Mhc that is filled by the rain event represents water savings. As illustrated in FIG. 27, for example, a given irrigated landscape may have an Mhc equivalent to 50,000 gallons of water, currently at or approaching a MAD level of 50%, a typical irrigation system would replenish the soil to 100% of Mhc (requiring 25,000 gallons of water). That same landscape, by example, if watered using this invention would water to a target of 80% of Mhc, requiring only 15,000 gallons of water (Target=50,000×0.8=40,000. Required=Target−Current=40,000−25,000=15,000). If 1″ of rainfall occurs the following day, the typical system would utilize almost none of the rain, whereas following the Target approach of this invention, the rainfall would take the soil to 100% of Mhc and 10,000 gallons of irrigation water would be saved.

Another advantage of utilizing a Target less than Mhc for irrigation scheduling is the potential to mitigate runoff from rain events. Depending on rainfall rates, the total volumetric total of runoff can be reduced by as much as the difference between Mhc (the amount typical irrigation systems water to) and Target (the amount this invention utilizes). Runoff creates significant environmental issues, and this advantage represents an important hedge against this issue. The volume of soil is determined from the surface area of an irrigation zone and a relevant root depth determined from the plant type in that area. The total amount of water that a soil volume can hold is then determined from the soil volume and the holding capacity of a unit volume of the soil. For instance, sandy soils have a different holding capacity than clay soils. The range of soil moisture is then determined from the microclimate factors, including plant type. For example, within each zone the plant type with the highest requirement for water can be determined.

The range is from a minimum, desired soil moisture to avoid excess stress to the plant (MAD), to a maximum desired soil moisture (Target). Once the desired range is established, various control strategies can be adopted, and the execution of those strategies involves directing a desired volume of water to the zone to make a specific adjustment to soil moisture within the range. Some examples of that strategy include not watering the zone every day so long as the soil moisture is within range, not watering on a day if rain is forecasted on the next day, and deliberately cycling the soil moisture between the lower portion of the range and the upper portion of the range. The resulting cycling from these types of strategies can save water while maintaining plant health, and can actually improve plant vigor as opposed to strategies that target maintaining a single set point (Mhc) for soil moisture.

### Enhanced Modeling

Another aspect of the current invention is more sophisticated modeling. For irrigation, the current invention typically models an irrigation site with over 15 parameters versus a limited number of basic parameters such as ET in prior techniques. In addition to ET, these new parameters may comprise
1. distribution uniformity,
2. stress level,
3. plant density,
4. slope,
5. sunlight,
6. paved surfaces,
7. humidity,
8. reflective surfaces,
9. structures (buildings),
10. water windows, having to do with the availability of water at different times,
11. calculated minimum and maximum application volumes,
12. calculated schedule cycling and soak times,
13. association to live rain-bucket sensors,
14. association to live temperature sensors (freeze sensing), and
15. association to live wind-speed sensors (irrigation blow-off).

### Shared Savings Business Model

Another aspect of the invention is a shared savings business model where the vendor provides a system, such as an irrigation system, and the customer only pays the vendor a portion of the savings obtained by using the system. The savings is typically established by comparing historical usage with current usage. This business model permits the customer to begin realizing savings without budgeting capital expenditure, and it begins saving water or other resources immediately. The model encourages the vendor to design and install systems that are economical, robust, and effective. The model is effective for the vendor because the monitoring and control system is highly effective at producing substantial savings.

### Environmental Credit Business Model

Another aspect of the invention is the opportunity to rapidly deploy improved control systems to save water for a community. In this example, an entity such as an oil and gas producer may be depleting a resource such as groundwater. That entity can offset the use of the groundwater by sponsoring a water-savings program for another entity. In one example, the first entity contracts with Acequia to deploy its irrigation management systems. Acequia installs and monitors the systems and measures the volume of water savings. This volume is then “credited” to the first entity to offset the waste of groundwater. This model is analogous to “carbon credits” which are an accepted way to . . . .

### Retrofit

Another advantage of the current invention is the ability to coordinate the control of valves on different main lines. This capability permits existing irrigation applications to be retrofitted with an enhanced control system as described in this specification without reconfiguring zones and valves. For instance a zone may be supplied by both a first controller on a first supply line and a second controller on a second supply line. The amount of water delivered to the zone will depend upon whether the first supply line only is open, the second supply line only is open, or both the first and second supply line are open. In prior art systems, it would be necessary for the first controller to communicate directly with the second controller. In the current invention, both controllers communicate to the server, and the server makes appropriate adjustments to compensate for which supply lines are open.

### BRIEF DESCRIPTION OF THE DRAWINGS

The following embodiment of the present invention is described by way of example only, with reference to the accompanying drawings, in which:

FIG. 1 is a block diagram illustrating a centralized, clock-based irrigation system;

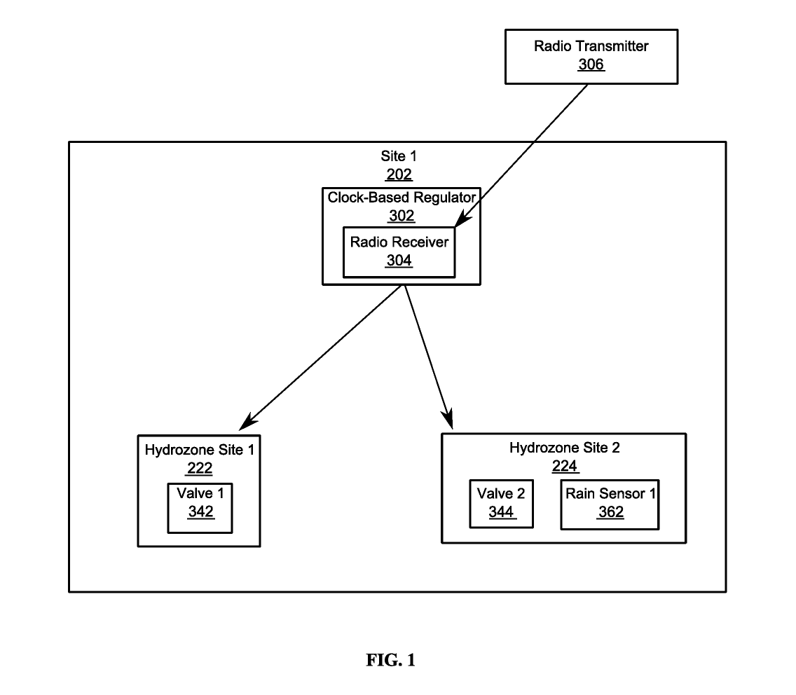

FIG. 2 is a block diagram illustrating a centralized, smart controller-based irrigation system;

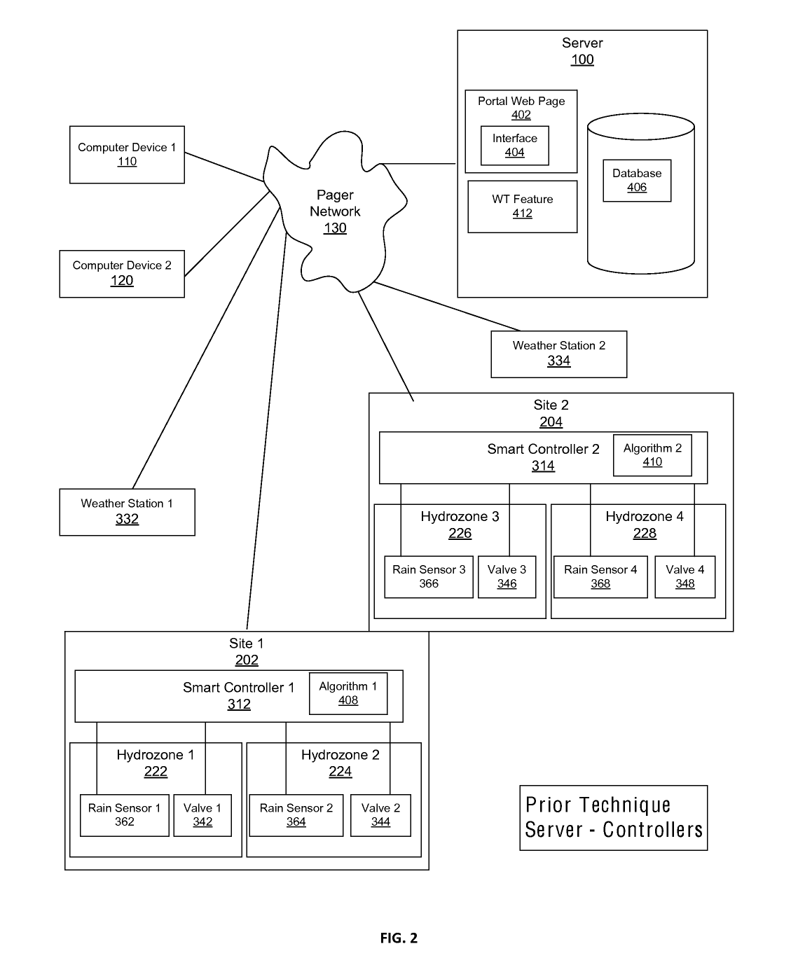

FIG. 3 is a block diagram illustrating an operating environment in which embodiments of the present invention may be deployed;

FIG. 4 is a flow diagram illustrating operations performed by the irrigation algorithms;

FIG. 5 is a block diagram illustrating an operating environment with a user interface for an irrigation system on one server and the database on another server;

FIG. 6 is a block diagram illustrating conceptual layers of the present inventions applicable to different industries;

FIG. 7 is a flow chart illustrating an embodiment of a method to regulate irrigation;

FIG. 8 is a block diagram illustrating types of input data;

FIG. 9 is a chart illustrating an optimum range for irrigation;

FIG. 10 is a flow chart illustrating best practices for irrigation management;

FIG. 11 is a flow chart illustrating steps accomplished by firmware;

FIG. 12 is a representative diagram illustrating a dashboard;

FIG. 13 is a representative diagram illustrating an expanded view of tabbed modules;

FIG. 14 is a representative diagram illustrating a superset of elements that may appear in modules;

FIG. 15 is a representative diagram illustrating elements of the module header common to all modules;

FIG. 16 is a representative diagram illustrating the Standard Hierarchy of the Tree View;

FIG. 17 is a representative diagram illustrating elements of the Tree View;

FIG. 18 is a representative diagram illustrating how the Tree View reflects the chosen hierarchy;

FIG. 19 is a representative diagram illustrating an example where only Controllers, Input Devices and Zones are selected, which is reflected in a simplified hierarchy of the Tree View;

FIG. 20 is a representative diagram illustrating how multiple modules can be placed into the same location;

FIG. 21 is a representative diagram illustrating a configuration that contains a set of modules on the top and (in this case) a single module at the bottom;

FIG. 22 is a representative diagram illustrating a configuration where the left side of the dashboard contains a set of layouts taking the full height of the display, and the right side is split top and bottom between two modules;

FIG. 23 is a representative diagram illustrating an embodiment of a dashboard map;

FIG. 24 is a diagram listing examples of dashboard modules useful for irrigation;

FIG. 25 is a representative diagram illustrating the Quick Tasks Module; and

FIG. 26A and FIG. 26B are block diagrams that illustrate a difference between a typical prior centralized technique and the present invention.

FIG. 27 is a graph comparing a maximum holding capacity (Mhc) irrigation strategy to a target based irrigation strategy where the target is between the Mhc and the minimal allowed soil moisture depletion (MAD).

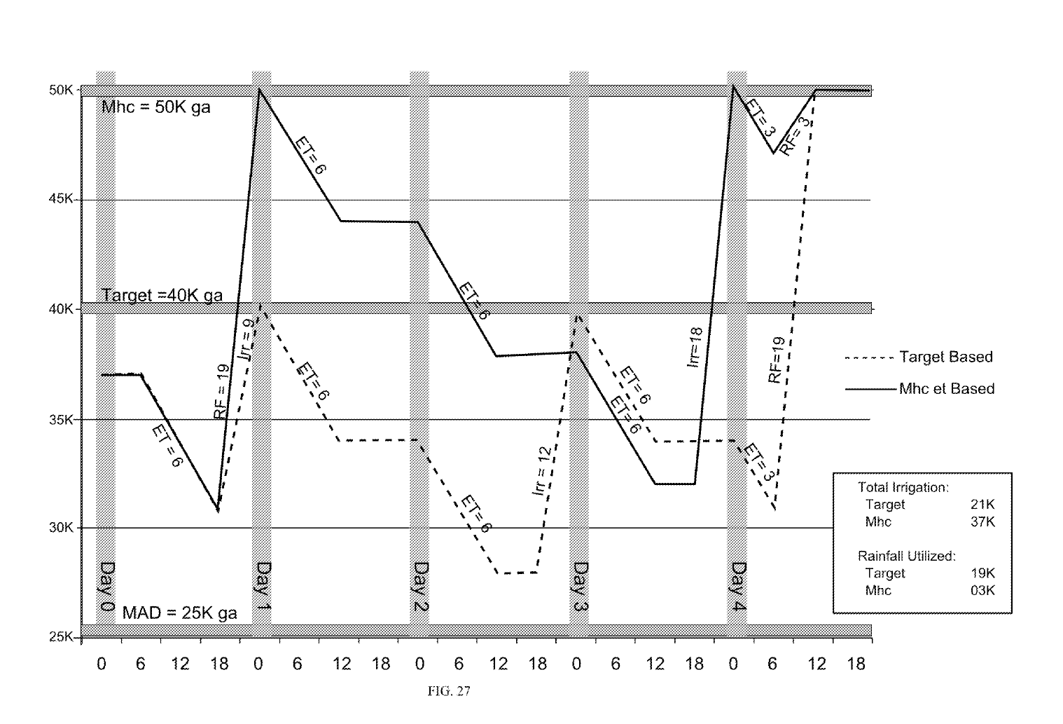

### DETAILED DESCRIPTION

### System

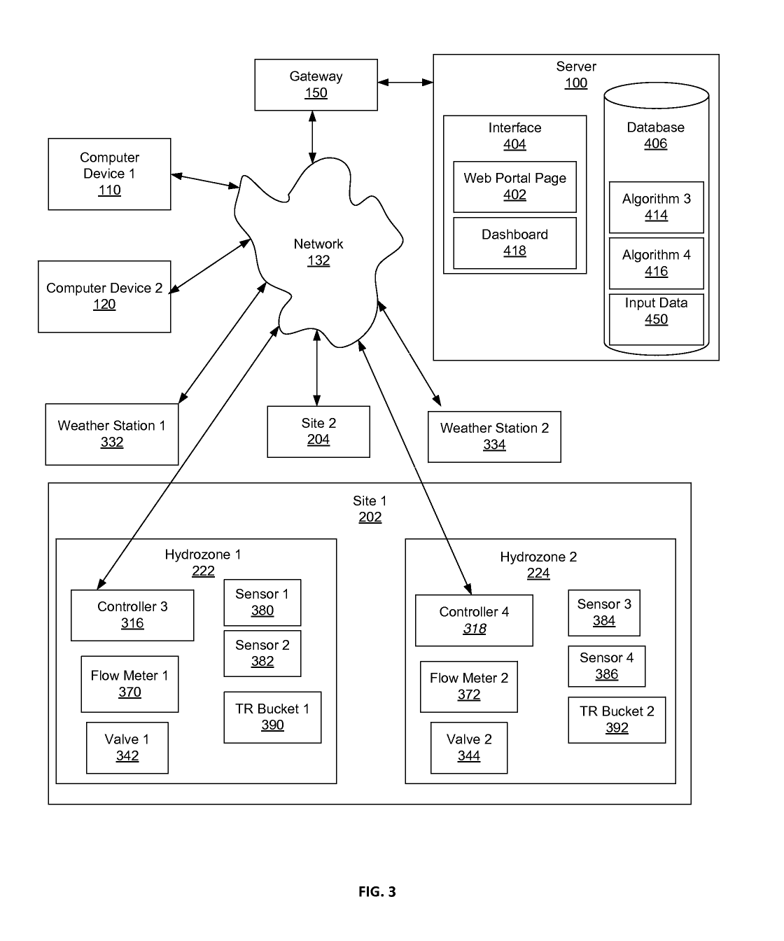

FIG. 3 shows an operating environment for an embodiment that may be used for automatically regulating irrigation, for example in the commercial landscape maintenance business where the end-users are irrigation managers. This system may be highly useful for water optimization at multiple irrigation sites 202 and 204. Site 202 is presented as a representative example of the components that may be used at other sites 204.

### System Components

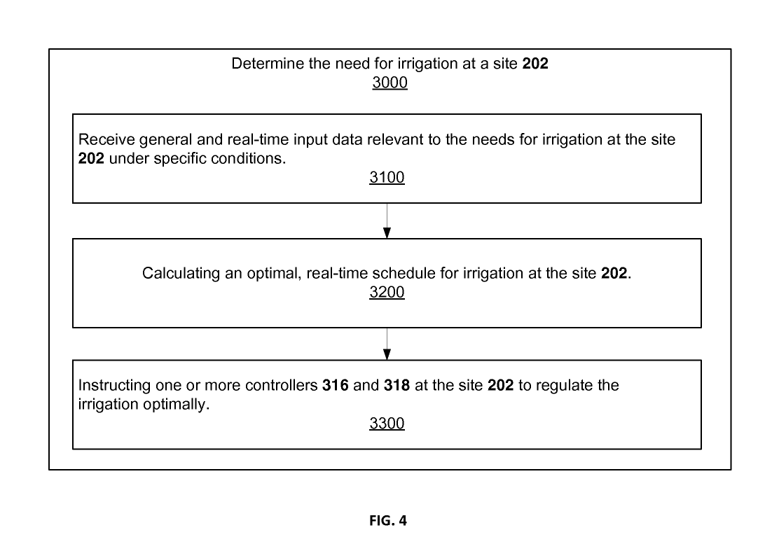

This embodiment may comprise the following elements:
At least one server 100
A user interface 404;
In an embodiment the user interface comprises
   a Web portal page 402, and
   a proprietary dashboard 418 for monitoring data and controlling application scheduling of irrigation, explained in detail below;
Range-based irrigation algorithms 414 and 416 for scheduling the application of water for commercial irrigation;
As shown in FIG. 4, in an embodiment these algorithms perform the following operations:
   1. Step 3100 in FIG. 4—Receiving general and real-time input data relevant to the needs for irrigation at the site 202 under specific conditions;
   2. Step 3200 in FIG. 4—Calculating an optimal, real-time schedule for irrigation at the site 202; and
   3. Step 3300 in FIG. 4—Instructing one or more controllers 316 and 318 at the site 202 to regulate the irrigation optimally.
A database 406, shown in FIG. 3, comprising non-volatile memory;
This is used to store input data 450 from devices at an irrigation site 202 and irrigation algorithms 414 and 416 for regulating irrigation at sites 202 and 204.
A wired network 132 for communications among elements associated with the system; The network 132 may be the Internet, a private LAN (Local Area Network), a wireless network, a TCP/IP (Transmission Control Protocol/Internet Protocol) network, or other communications system, and may comprise multiple elements such as gateways, routers, and switches.
An irrigation gateway 150 that communicates directly with various types (makes and models) of field controllers 316 and 318 and translates the messages into a common command set usable by the server process.
One or more controllers 316 and 318 at an irrigation site 202; These are non-decision-making controllers that are not equipped with irrigation algorithms.
One or more automated, electrically controlled water valves 342 and 344 at an irrigation site 202 that the controllers 316 and 318 control for irrigation;
One or more sensors 380, 382, 384, and 386 at an irrigation site 202 that transmit information about the irrigation site 202 to the server 100;
For example, in different embodiments they may comprise all or any of the following:
   Soil moisture probes that provide information about the soil moisture level at the site 202;
   Soil temperature probes that report on the temperature of the soil at the site 202;
   Air temperature probes that report on the temperature of the air at the site 202;
   Rain sensor that report on the presence of rain at the site 202.
   Tipping rain (TR) buckets 390 and 392 that measure the amount of rainfall into the buckets at the site 202.
One or more flow meters 370 and 372, also called hydrometers, at an irrigation site 202 that measure the actual flow of water through the flow meter 370 and 372;
One or more weather stations 332 and 334 that monitor the weather conditions pertinent for irrigation at an irrigation site 202; and
One or more computer devices 110 and 120 that can access the interface 404 to monitor and control irrigation at an irrigation site 202.
These computer devices 110 and 120 may comprise any computer-based devices, for example PCs, laptops, PDAs (personal data assistant), and cell phones.

### Other Operating Environments

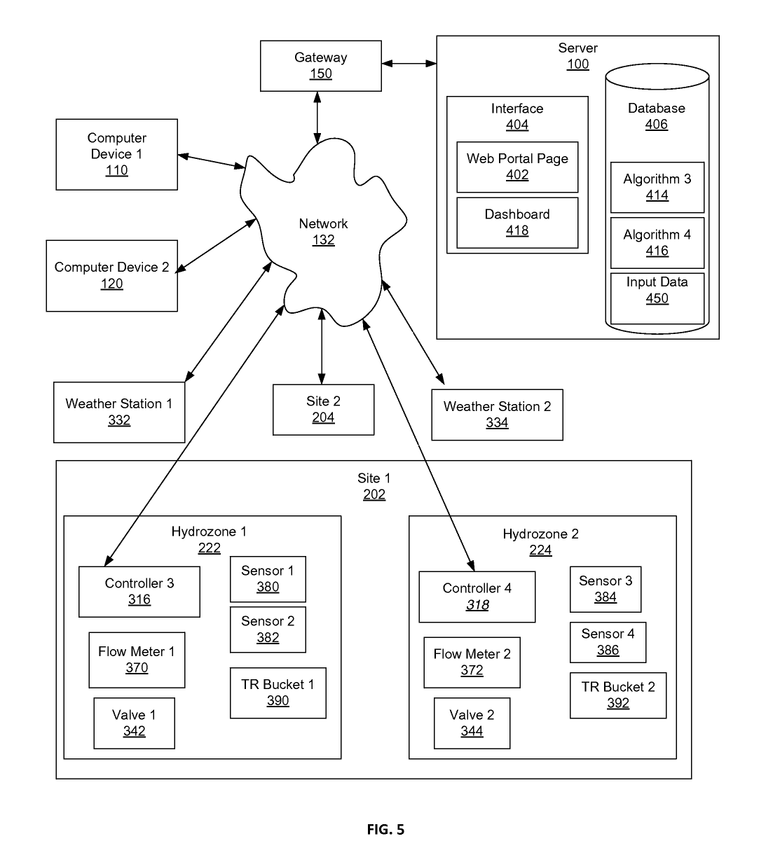

In other embodiments, the elements for the irrigation system shown above may be used in different operating environments known to those skilled in the art. For example, FIG. 5 shows an operating environment where the user interface 404 for the system may be on one server 100 and the database 406 may be on another server 102.

### Other Industries

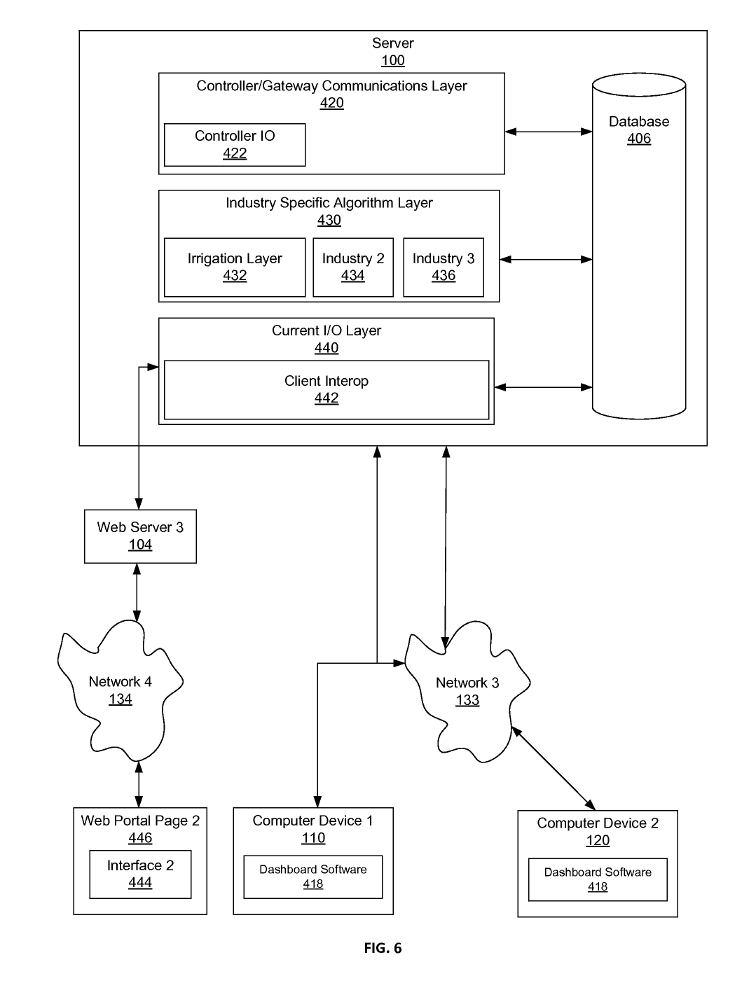

In still other embodiments, the system and method of the present invention that are explained in this patent specification for the irrigation industry may be used in other industries that may benefit from centralized regulation, for example the gas industry and the air conditioning industry. As illustrated in FIG. 6, server 100 may comprise the following conceptual layers:
A controller/gateway communications layer 420.
This layer represents applications designed to permit controller I/O 422
communications over wired or wireless network 3 133 with different types of gateways used by different industries, such as the gas industry and the air conditioning industry.
An industry-specific algorithm layer 430.
This represents different algorithms designed to regulate the flow of material specific industries, 432, 434, and 436. For example, industry 2 434 could represent the gas industry, and industry 3 436 could represent the air conditioning industry.
A client I/O layer 440.
This represents applications designed to permit client interop 442 communications over wired or wireless network 4 134 and Web portal page 2 446 and an interface 2 444 with different clients. It also permits communications over wired or wireless network 3 133 with computer devices 110 and 120, which may run copies of the dashboard software 418.

### Method

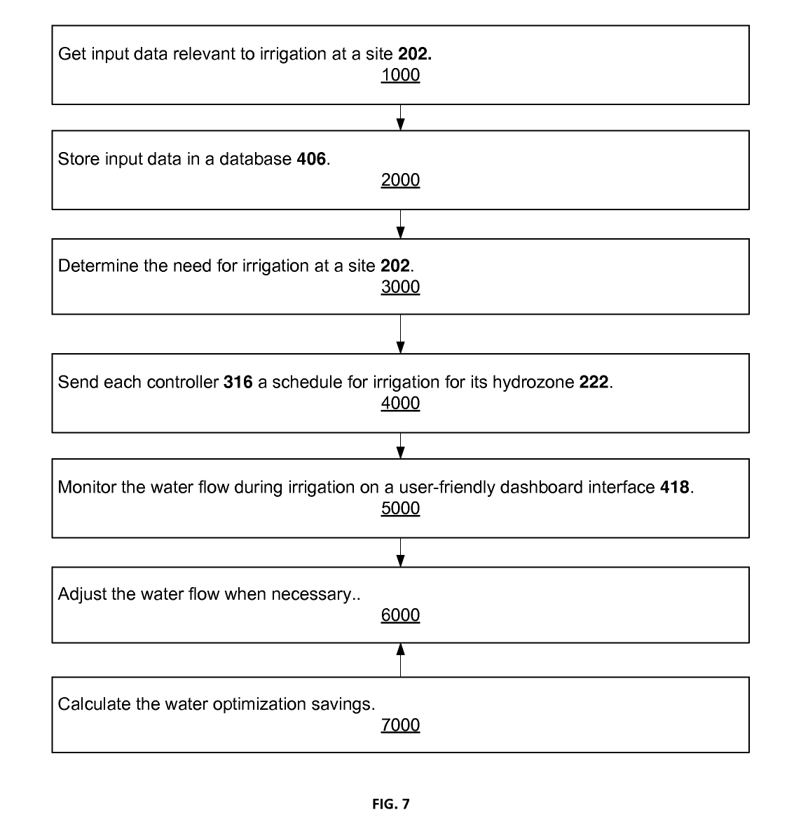

FIG. 7 shows an embodiment of a method to regulate irrigation through the operating environment shown in FIG. 3.

Step 1000 in FIG. 7—Get Input Data Relevant to Irrigation at a Site 202.

For example, such data may be obtained from an initial survey of the irrigation site 202, shown in FIG. 3, from the controllers 316 and 318 and sensors 380, 382, 390, 384, 386, and 392 at the irrigation site 202, and from weather stations 332 and 334 in the area of the irrigation site 202. The sensors 380, 382, 390, 384, 386, and 392 may be called RTUs (remote transmission units).

Step 2000 in FIG. 7—Store Input Data 450 in a Database 406.

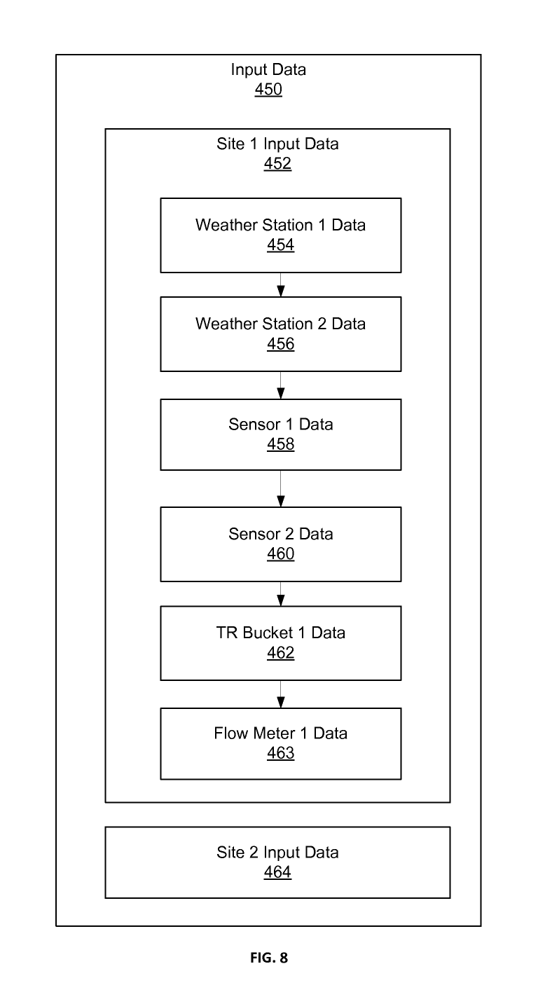

The input data mentioned in connection with Step 1000 may be stored for further use in database 406, shown in FIG. 3, as files of input data 450. FIG. 8 shows that the input data 450 may comprise files of information for different sites 452 and 464. Moreover, an input data file for a site 452 may comprise multiple files from different input sources, such as
Weather station 1 data 454,
Weather station 2 data 456,
Sensor 1 data 458,
Sensor 2 data 460, and
TR bucket 1 data 462, and
Flow meter 2 data 463.

Step 3000 in FIG. 7—Determine the Need for Irrigation at a Site 202.

These needs are typically a function of the plant type, soil, and environmental factors. They are automatically determined through proprietary algorithms such as algorithm 3 414, shown in FIG. 3, which are stored in database 406 and which calculate the need from the input data 450 and calculate irrigation schedules at the individual hydrozone level 222 for a site 202. Thus, separate calculations may be made for each hydrozone, 222 and 224, at a site 202. In embodiment, such an algorithm 3 414 may comprise a range-based irrigation algorithm.

### Range-Based Irrigation Algorithms

In an embodiment, the algorithm 3 414 used for irrigation calculations may comprise a range-based irrigation algorithm. Such an algorithm calculates the optimum range of irrigation time for the specific plants and conditions at a hydrozone 222, rather than calculating a single amount of moisture to be maintained in the soil.

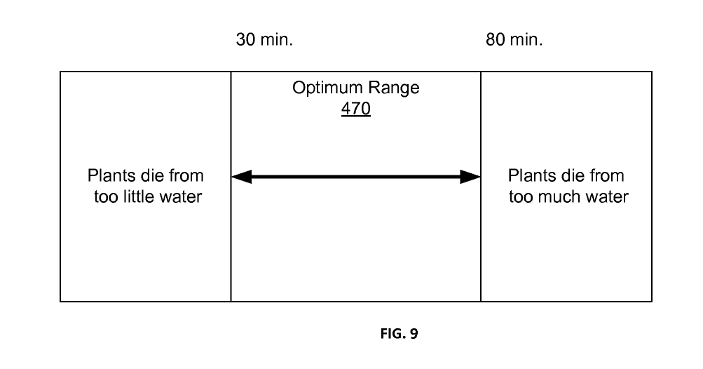

For example, FIG. 9 shows that for plants of a specific type under certain weather, soil, slope, and water-flow conditions, the optimum range 470 for irrigation may lie between 30 and 80 minutes. Watering for less than 30 minutes or more than 80 minutes may be harmful to the plants.

### Example of Elements of a Range-Based Irrigation Algorithm

The following example shows useful elements for a range-based irrigation algorithm:

Auto Schedule High-Level Calculations

Step 1: Determine Current Soil Moisture per Hydrozone

| Current Soil Moisture = | |
|---|---|
| | Previous Soil Moisture |
| − | ET (ga) |
| + | Rainfall (ga) |
| + | Previous Irrigation (ga) |

ET (Evapotranspiration) =
Calculated per zone using 14 or more environmental factors
(such as Soil Type, Root Zone Depth, etc.).

Step 2: Determine Water Requirements

| Forecasted Soil Moisture in 24 Hours = | |
|---|---|
| | Current Soil Moisture |
| + | Estimated ET |

if (Forecasted Soil Moisture < Minimum Allowable Soil Moisture) then

WR (Water Requirements, per zone) =

| | |
|---|---|
| − | Target − |
| | Current Soil Moisture |

where Target (Target Soil Moisture) is determined by crop type
else

WR = 0

Additional Considerations
Poor Distribution Uniformity (ability to uniformly distribute water) adds to the water requirements.
Maximum Runtime per Zone is also dependent upon runoff factors (primarily soil type and slope). Such that a maximum amount of water can be applied per zone before all water becomes runoff. When WR exceeds Maximum Per Zone values, the schedule is automatically broken into cycles, with soak times between.
Previous Irrigation is based on Metered Flow. Thus, WRs are calculated using actual water amounts, vs. estimations or predictions alone.
Previous Irrigation includes any water applied to the zone, including that which is applied by manual schedules.
Rainfall is gauged per zone, in the following order of precedence: User Override, Rainbuckets Data, Weather Station Data.
ET and Rainfall amounts can be manually adjusted.

Step 4000 in FIG. 7—Send Each Controller 316 a Schedule for Irrigation for its Hydrozone 222.

In an embodiment, an irrigation schedule may be based on total volume constraints, priority of need, and multiple-pass application such as slopes for an individual hydrozone 222, shown in FIG. 3.

Step 5000 in FIG. 7—Monitor the Water Flow During Irrigation on a User-Friendly Dashboard Interface 418.

Data input from a flow meter 370, shown in FIG. 3, at a hydrozone 222 may be stored in database 406 as flow meter data 463, shown in FIG. 8. An algorithm 414, shown in FIG. 3, may then be used to translate flow meter data 463, shown in FIG. 8, into a displayable format on dashboard interface 418, shown in FIG. 3 and explained in more detail below. Employees and customers can than access dashboard interface 418 to monitor irrigation through a water valve 342 at a hydrozone 222.

Step 6000 in FIG. 7—Adjust the Water Flow when Necessary.

Employees and customers can use that dashboard interface 418, shown in FIG. 3, to manually manage the water flow through a water valve 342 at a hydrozone 222. Their decisions may be based on the display of input data 450 from multiple sources, explained above, such as real-time weather conditions.

Step 7000 in FIG. 7—Calculate the Water Optimization Savings.

This calculation is automatically determined through proprietary algorithms such as algorithm 3 414, shown in FIG. 3.
Water Optimization through Range-Based Scheduling

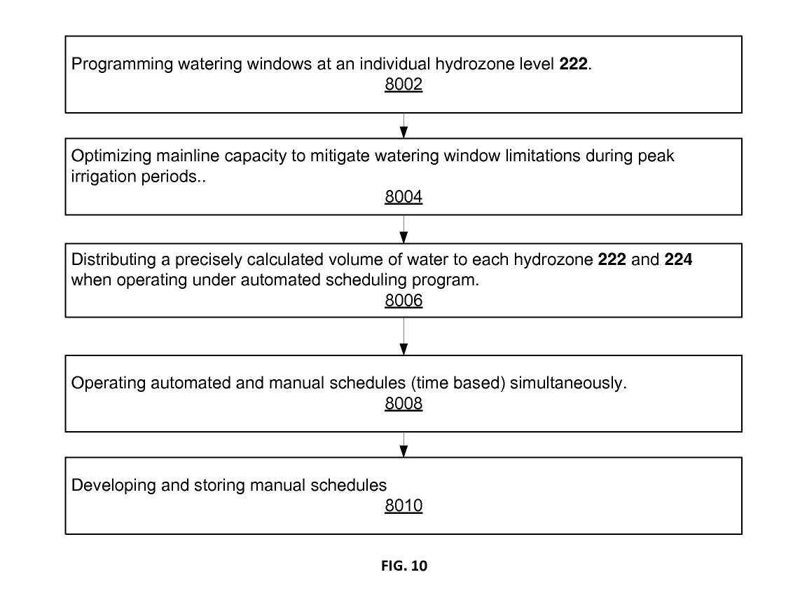

The irrigation system and method presented greatly facilitates true best practices irrigation management through the following steps, shown in FIG. 10:

Step 8002 in FIG. 10—Programming watering windows at the individual hydrozone level 222, shown in FIG. 3.

Step 8004 in FIG. 10—Optimizing mainline capacity to mitigate watering window limitations during peak irrigation periods.

Step 8006 in FIG. 10—Distributing a precisely calculated volume of water to each hydrozone 222 and 224 when operating under automated scheduling program;

An example of how “water use optimization” differs from “water conservation” involves irrigation scheduling techniques during the hot and dry summer months. By scheduling irrigation on heavily sloped areas in multiple short applications rather than a single long application, a planned reduction in water use may not be occurring, but we can ensure that the water applied is actually absorbed into the soil and produces the desired cosmetics rather than mostly running off in to storm drains.

Step 8008 in FIG. 10—Operating automated and manual schedules (time based) simultaneously.

Manual schedules may be needed when flow meters 370 and 372 are not present or are not operational.

Step 8010 in FIG. 10—Developing and storing manual schedules. Manual schedules are those schedules created by a user, in lieu of, or simultaneous to, an automatically generated schedule.

In an embodiment, manual schedules are created with the dashboard interface 418, shown in FIG. 3, pda interface, or Web portal page 402. The user specifies 1) one or more hydrozones 222 and 224, 2) the start time, 3) the duration in gallons, inches or time, and 4) the sequence of each hydrozone 222 and 224 within the set. Additionally the user specifies the number of cycles for this set to run. The commands are processed through the server 100 to the controllers 316 and 318. When the required flow meters 370 and 372 are present, a determination of all water applied from manual schedules is accumulated and used in the calculation for future water requirement needs.

Example of an Irrigation Embodiment—Aquador.NET

The Aquador.NET technology by Acequia, Inc. provides the mechanics and platform for the exchange of real-time data and automated processing of business decisions between field irrigation controllers, a server process, and a rich client user interface. The following sections show examples of components used by the Aquador system to accomplish the irrigation system explained above.

### Server

In an embodiment, the server 100 is a process application that:
Resides in a central location.
In an embodiment, the server 100 is a single process (a computer program) optimized for performance on a Windows-based server. Server redundancy is built-in using RAID “Redundant Array of Inexpensive Disks” technology. A back-up server provides internal network redundancy and facilitates the ability to perform preventive maintenance on the primary server. In an embodiment, external network redundancy may also be used.
Stores raw data and information in a central database 406.
In an embodiment, the server 100 obtains the raw data, either through event notification from a SCADA Sub-system, or through a ‘pull’ command issued to the SCADA Sub-system. SCADA is an acronym for Supervisory Control and Data Acquisition, a computer system for gathering and analyzing real-time data.
Executes advanced analysis and supervisory control.
Although the SCADA Sub-system analyzes the data and executes simple supervisory control, the Aquador.NET Server is able to conduct more thorough analysis of the data, convert it to ‘information’, and conduct advanced supervisory control over the SCADA Sub-system.
Establishes and maintains communication.
The server 100 and client, such as a client at computer device 1 110, working in tandem, manage and maintain an open connection with each other.

### Controllers

In embodiments, SCADA, MOSCAD or other field irrigation controllers 316 and 318 with external communication capability, may be used. SCADA technology may be used because it is dependent upon receiving raw data, automatically analyzing the data, and executing supervisory control. However, the present invention achieves the real-time distribution of “information” as well. To be more specific, “information” is the result of the analysis of data, and the present invention distributes information to end users as “virtual information objects.”

The SCADA sub-system is independent of the present invention. A simple interface is required to integrate the SCADA sub-system into the present invention's s server.

### Firmware

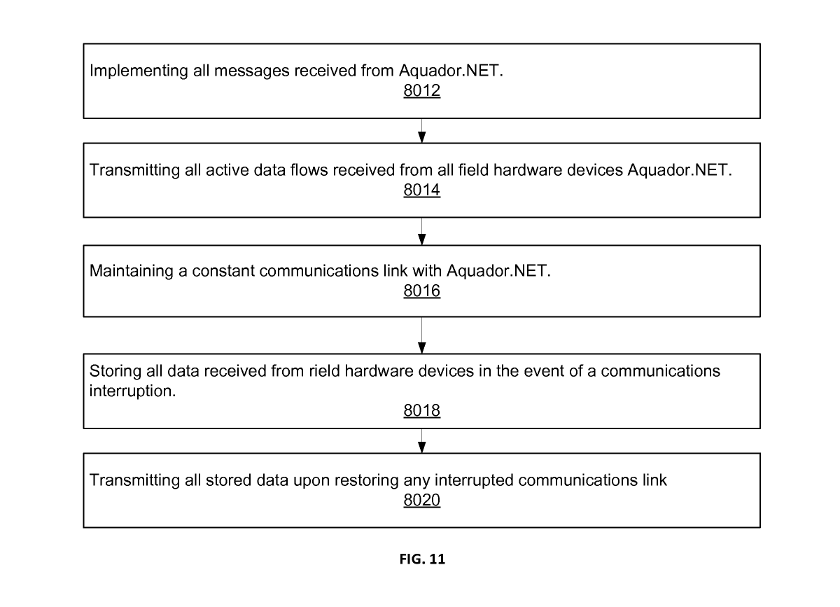

Proprietary firmware is used on the RTUs and the Motorola MOSCAD controllers and is responsible for the following steps, shown in FIG. 11:

Step 8012 in FIG. 11—Implementing all messages received from Aquador.NET;
Step 8014 in FIG. 11—Transmitting all active data flows received from all field hardware devices to Aquador.NET;
Step 8016 in FIG. 11—Maintaining a constant communications link with Aquador.NET;
Step 8018 in FIG. 11—Storing all data received from field hardware devices in the event of a communications interruption; and
Step 8020 in FIG. 11—Transmitting all stored data upon restoring any interrupted communications link.

### Modems

In an embodiment, off-the-shelf and highly tested Siemen's AG cell to IP (cellular to internet) modems may be used for two-way data communications along with direct Ethernet connections.

### Water Valves

Master water valves 342 and 344 are placed at the point that each water source enters the irrigation site. These valves 342 and 344 are closed when irrigation is not occurring, to eliminate constant seeping and are closed automatically when a mainline leak/break is detected.

### Flow Meters

The streaming of real-time data from flow meters 370 and 372 on each mainline facilitates the execution of automated watering schedules, leak detection, detection of stuck valves, and precise watering based on hydrozone-by-hydrozone environmental data.

### Tipping Rain Buckets

Spotting at least one and sometimes two tipping rain buckets 390 and 392 on larger sites 202 facilitates the amendment or interruption of in-progress irrigation schedules or the cancellation of irrigation schedules to be executed in the next 24 hours.

### Sensors

Spotting sensors 380, 382, 384, and 386 in strategic locations around each site 222 provides highly useful input data 450 for automatic scheduling, monitoring in displays, and manual adjustments of irrigation. For example, soil moisture probes can provide soil-moisture-audit data to compare to algorithm-derived soil moisture calculations and ensure that sufficient soil moisture is maintained.

### Database

For irrigation, the database 406 is simply a data store structured for the specific types of data and information to be stored, in an embodiment, as a result of the selected SCADA industry. For other industries, industry-specific databases are built, as shown in FIG. 6.

### Virtual Information Broker

Technically, the Aquador.NET Virtual Information Broker distributes information between the Aquador.NET Server, such as server 100 shown in FIG. 3, and Client applications, for example on computer device 1 110, in real time. It is created by the Aquador.NET Server 100 upon its first start-up. Only one virtual information broker is created as a singleton object and its function is to allow Aquador.NET Clients to subscribe over a TCP/IP (Transmission Control Protocol/Internet Protocol—a standard protocol allowing computers to connect and communicate to a network, such as the Internet) connection to it for specific information—meaning anyone, anywhere in the world with internet access can connect to the Server 100 from the Client. Not all information processed by the Aquador.NET Server 100 from the controllers 316 and 318 is distributed to the Aquador.NET Client, only the information subset to which the Client subscribes. The information broker establishes virtual information objects with properties, methods, events, etc., that are common to object oriented programming techniques (a standard in programming concepts, generally used to describe a system that deals primarily with different types of objects). New objects can be instantiated or created by the broker as needed for brokering the information between the Server 100 and the Client. Properties in the virtual information objects can be set and methods can be called by either the Server or Client; and, events can be fired to the Server 100 or Client.

Simply stated, the Aquador.NET Virtual Information Broker allows users to “subscribe” to receive the information needed by the user. Once subscribed, the Virtual Information Broker then delivers the information to the user automatically. The “subscription” itself is transparent to the user, as it is programmatically implemented in the Graphical User Interface (“GUI”) of the Aquador.NET Dashboard.

### Dashboard

In an embodiment, the dashboard 418, shown in FIG. 3, is designed to be highly customizable and configurable for each user and user type. For example, a supervisor may need routinely work with a specific set of modules, where a field operator may use a completely different set when doing one task, and yet another set when doing another task.

There are two primary means of customizing the dashboard:
User selection and layout of modules.
Modules are self-contained units of functionality within the dashboard 418, which fall under a number of specified categories. Each layout (providing the user has the necessary security) can be loaded by the user, and (optionally) docked anywhere within the dashboard 418. The selection and position of these modules is saved in user layouts (see below).
User editable layout for the modules.
Layouts preserve, through persistent storage, the user's selection and location of selected modules, thus preserving the visual state of the dashboard 418 between uses. Most modules themselves will also preserve their individual user settings between sessions.

### Elements of Dashboard

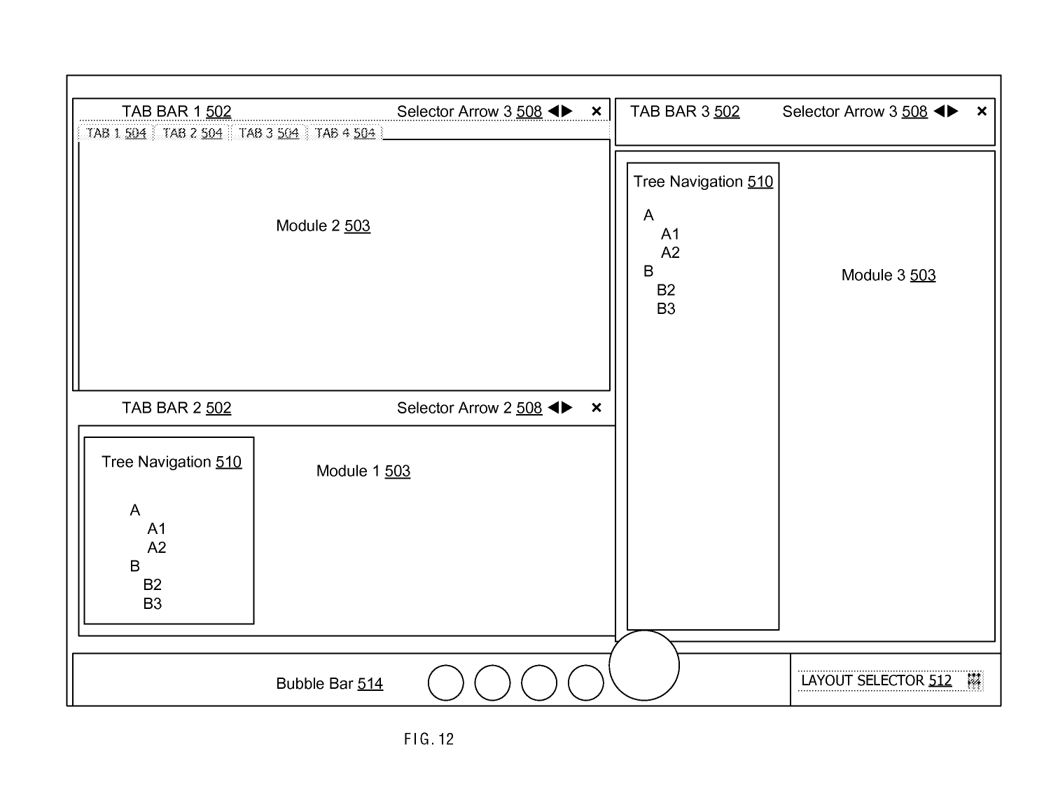

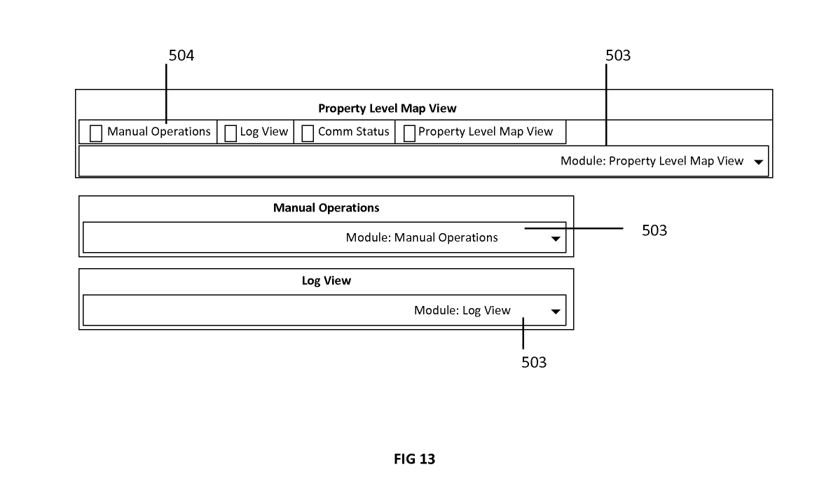

FIG. 12 shows an example of a dashboard 418 with the following elements:
Tab bars 502 with tabs 504 for modules 503. FIG. 13 shows an expanded view of typical tabs 504. Each tab 504, shown in FIG. 12, in the tab bar 502 represents a separate module 503. To active a module 503, the user selects the tab 504. To close a module 503, the user first selects it and then clicks the “X” button 506 on the right end of the tab bar 502. The user can employ the arrows 508 at the right end of the tab bar 502 to select tabs 504 that may be obscured, if the screen is too small to display all modules 503. To move a module 503, the user drags the tab 504 to a new location.
Tree navigation 510.
A layout selector 512.
The layout selector provides quick access to the current user's list of saved layouts.
A bubble bar 514.
There are two tabs for the bubble bar. The “Main” tab provides quick access to a number of program features, and the “Quick Modules” tab provides a quick way to load the most popular modules. The user can hover the cursor over each icon to see an enlarged version of the icon and a short description of its purpose.

### Modules

Modules 503, shown in FIG. 13, are self-contained dockable windows that are categorized by function. They can be selected by the user, based on secure rights assigned by an administrator. And they can be moved and docked or undocked into any number of visual configurations based on user preference and need.

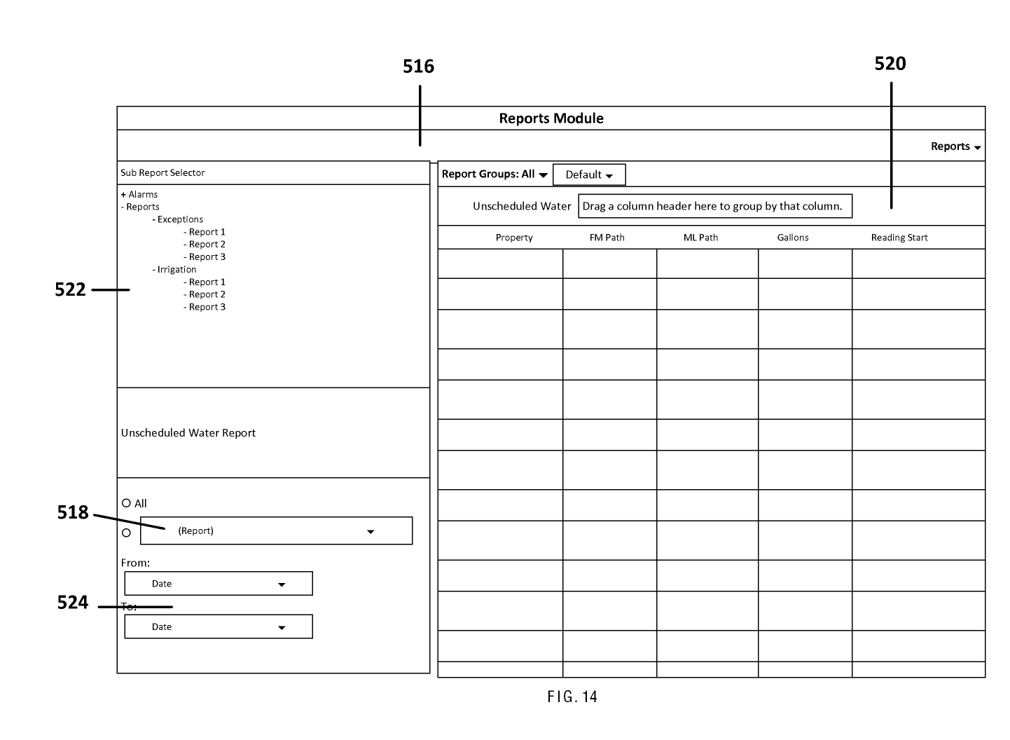

FIG. 14 shows a superset of the elements that may appear in modules, though particular modules may use subsets of those elements:
Module header 516,
Pop-up tree navigator 518,
Group-by grid control 520,
Sub-module selector 522, and
Additional input or criterion controls 524.

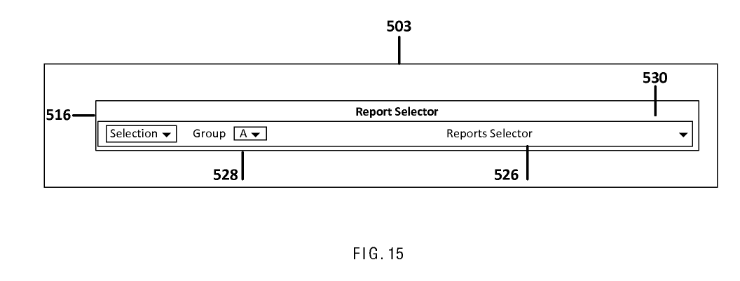

FIG. 15 shows elements of the module header 516 common to all modules 503:
A module selector 526.
This allows the user to change the instance of that module into another module.
A module group selector 528.
Most modules may be grouped together. Grouped modules are linked so that a selection in one module, (typically using the tree navigation system 510, shown in FIG. 12, will automatically reflect in all modules within the same group.
A module location selector 530.
This allows the user to move the module to a different physical location within the dashboard 418, shown in FIG. 3.

Modules are all able to be sized and docked to any number of places within the dashboard 418, by:
Using the module location selector 530, shown in FIG. 15, which provides a description of the new location (for example “Dock Top”, which locates the module 503 at the top most pane of the Window)
Dragging the module header 516 from its current location. Modules 503 can be docked onto each other to form tabs 504, shown in FIG. 12, or to the right, left, top, and bottom of existing modules, to produce window groupings.

The following list shows other typical elements and features of modules 503:
Custom Tree View Navigation System 510.
The Tree Navigation System 510 is a dual control consisting of a Tree View and a List View. The Tree Navigation System 510 is searchable, and filterable, and it operates under two modes and two formats:

Modes
1. Single-Select Item Control. Checkboxes are absent, only one item in the tree is selected, and the Listview control is not present.
2. Multiple Selection Control. Checkboxes are present, as well as the listview.

Formats
1. Stand-Alone Control. This is expanded and visible at all times.
2. Popup Control. This collapses to a single line control displaying the selected item, but, when clicked, expands out as a Popup Window with “OK” and “Cancel” buttons to collapse and select or ignore the selection.

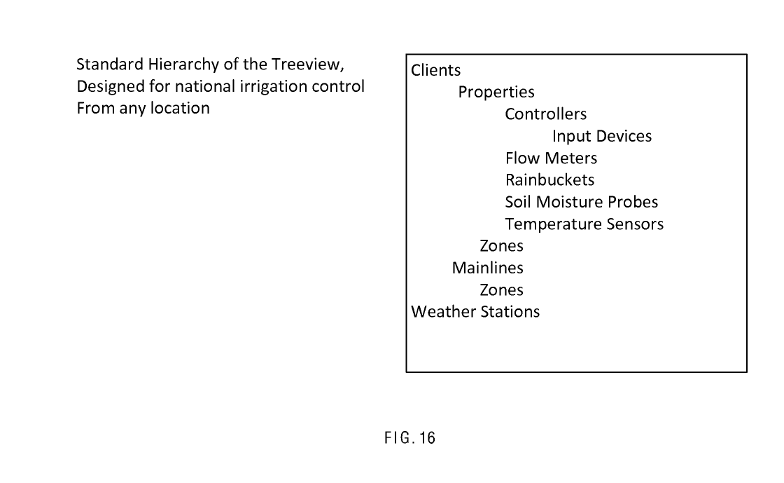

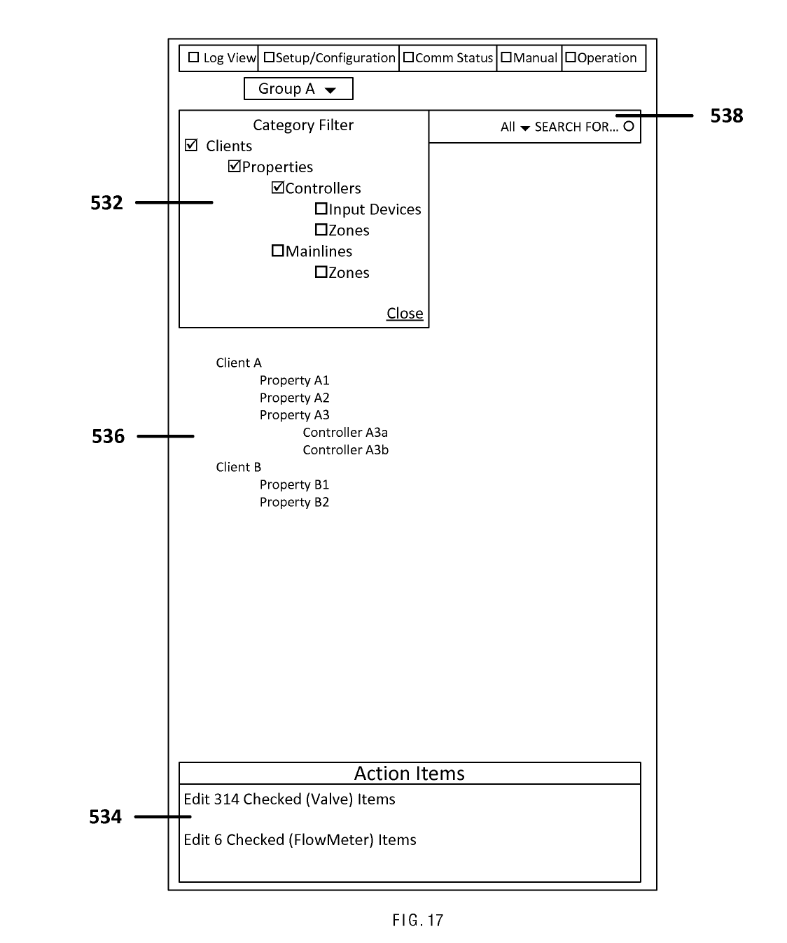

The elements contained in the Tree View, shown in FIG. 17, are arranged according to a customizable hierarchy specific to a National Irrigation Control System. The Standard Hierarchy of the Tree View, shown in FIG. 16, allows easy, strategic access, control and management of irrigation systems across multiple clients and properties. The specific display of elements within the hierarchy is limited based on user login credentials and assigned rights.

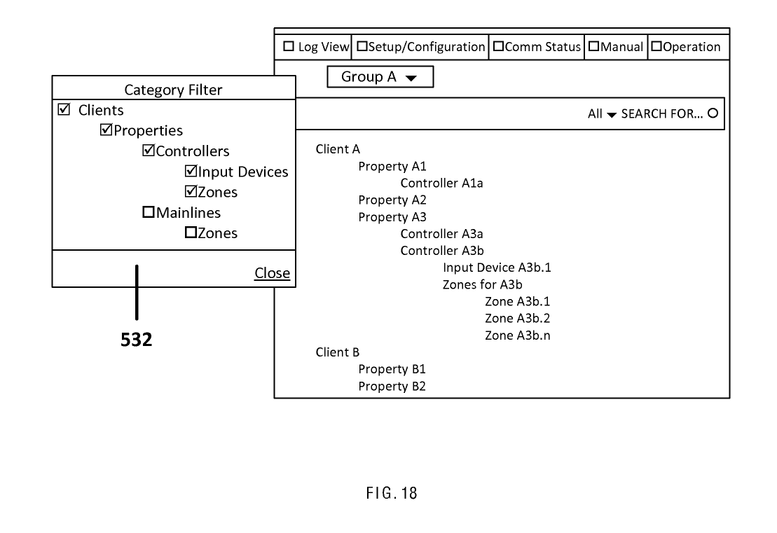

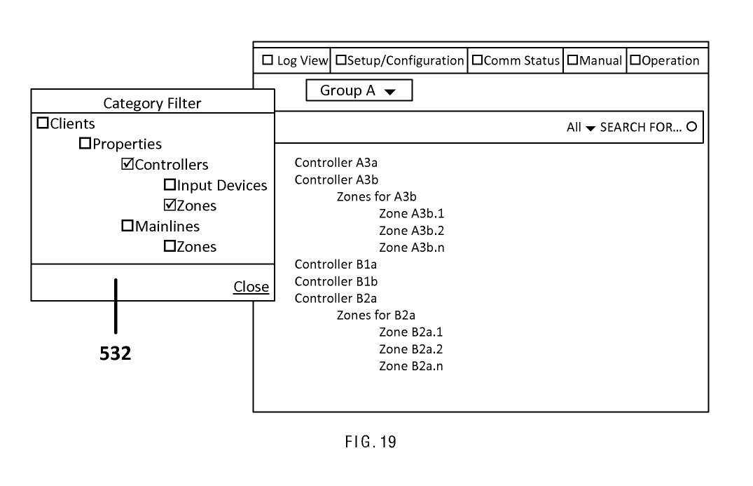

In an embodiment, the elements of the Tree View comprise
A Tree Navigation Hierarchy Selector 532, shown in FIG. 17.
Not only are the actual hierarchy items selectable, but the hierarchy itself is selectable using the Tree Navigation Hierarchy Selector 532. By checking or unchecking items in the Hierarchy Tree Navigation Hierarchy Selector 532, the groupings and display of elements within the Tree View are altered.
A List View Selector 534. As items are checked or unchecked in the Tree View they are added or removed to and from the listview. Removing items from the listview unchecks the item from the Tree View.
A Multi-Selection Filterable Tree View 536.
This has tri-state selection check boxes. With tri-state selection, parent objects are checked black when all sub-items are checked, unchecked when none are checked, and checked gray, when some child items are selected.
A Search feature 538.
This allows searching for items in the Tree View.
As shown in FIG. 18, by having all items in the Tree Navigation Hierarchy Selector (“Object Filter” as shown), the tree view reflects the chosen hierarchy.
FIG. 19 shows an example where only Controllers, Input Devices and Zones are selected, which is reflected in the simplified hierarchy 540 of the Tree View.

### Examples of Dashboard Layout

This section provides several examples of user-defined layouts of the dashboard 418, shown in FIG. 3. The options for layout positions are literally infinite. A layout can be saved to the server 100 per user, for retrieval from any dashboard 418 on any computer devices, such as 110 and 120 in FIG. 6. Layouts may be shared among users. A layout contains the selection of modules 503, shown in FIG. 12, each module's settings at the time the layout is last saved, and the location of each module on the screen.

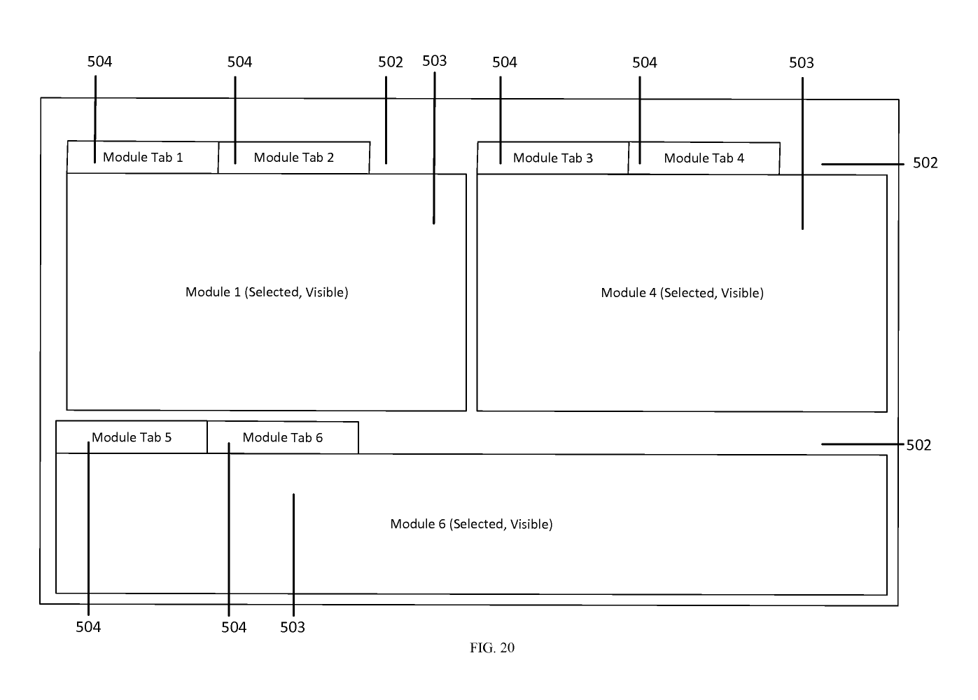

As shown in FIG. 20, multiple modules 503 can be placed into the same location. In this scenario, each module 503 is viewed as a separate tab 504. The tabs 504 can be re-arranged, by dragging left or right. To undock a module 503, the user can drag the tab 504 off the tab bar 502 into an open space. To close the module 503, the user can click the “X” button at the far right end of the tab bar 502, or undock the module 503, and close it.

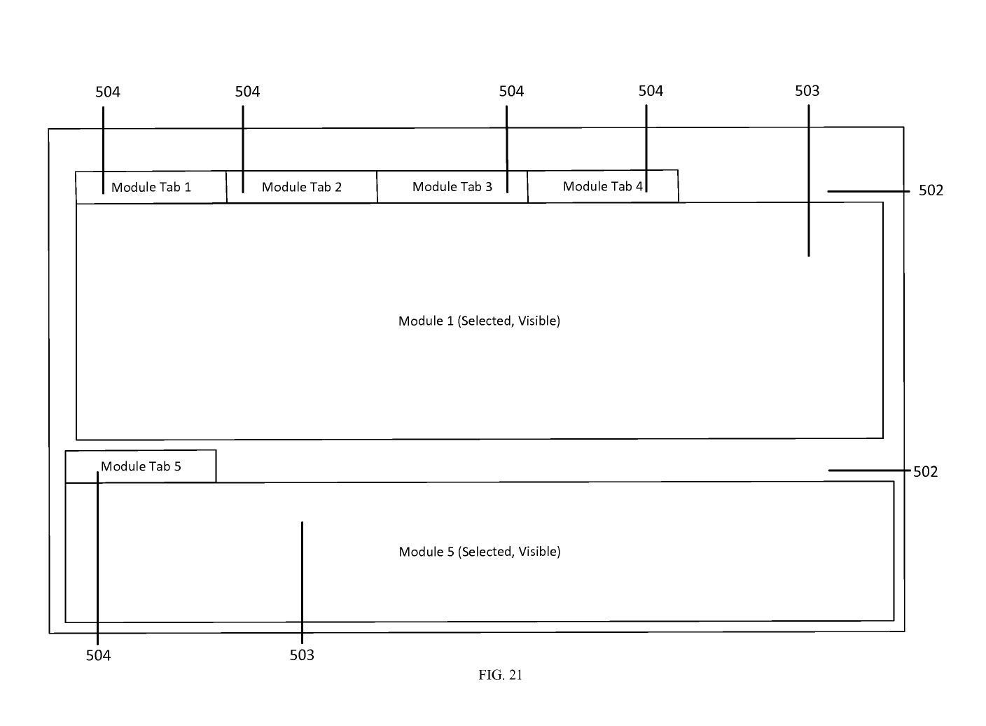

FIG. 21 shows a configuration that contains a set of modules on the top and (in this case) a single module at the bottom.

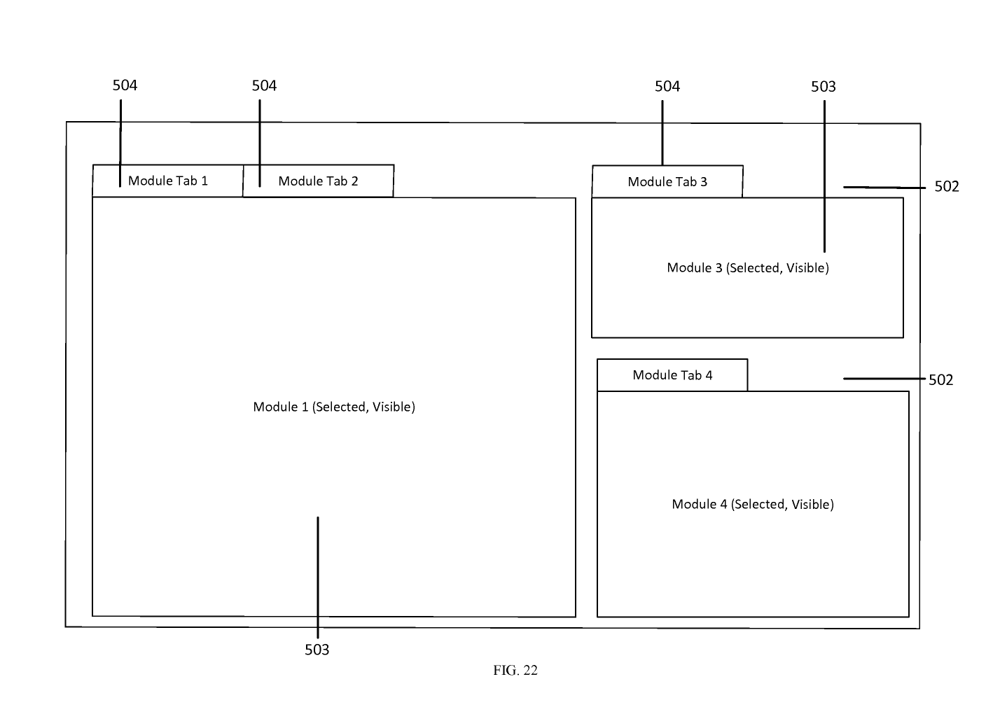

FIG. 22 shows a configuration where the left side 542 of the dashboard contains a set of layouts taking the full height of the display, and the right side 544 is split top and bottom between two modules.

### Dashboard Maps

A Map Maker tool lets a user layout a visual display of a physical site. Maps can then be used in the Map Module. Maps used in the Map Module are live maps, meaning they can be zoomed and panned; and the elements on the map, such as controllers, valves, hydrozones, rainbuckets, and flow meters, provide visual clues as to their status real-time. For example, when a valve opens it is animated and changes color.

Objects placed on the map are also interactive, with a context menu. A user right-clicks the object (such as a valve), and selects an action item (such as “Open Valve”).

The Map includes a very sophisticated means of linking objects using Org-Chart like tools to show relationships among them. Such relationships can be created automatically by selecting an object, and, using the context menu, selecting “Find Related Objects.” The related objects are then linked using lines and arrows to highlight both the linkage and direction of link (parent to child, such as Controller to its Valves, or sibling, such as valve to valve).

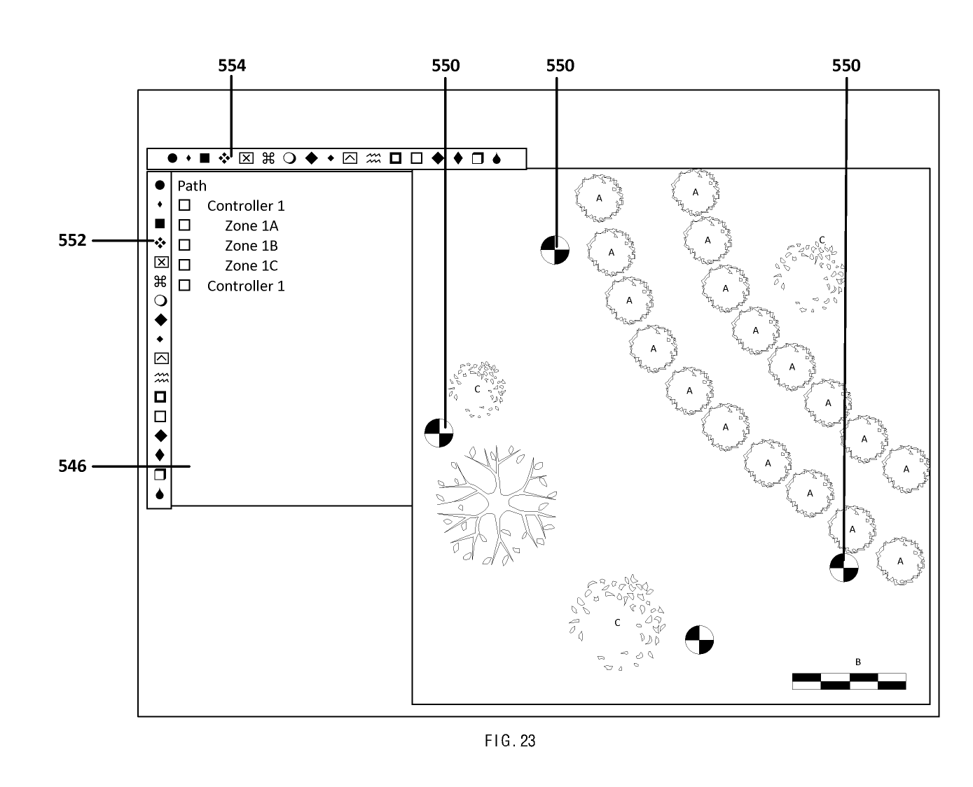

FIG. 23 illustrates an embodiment of a dashboard map comprising the following elements:
Tree View Selector 546.
Objects can be dragged directly from the Tree View Selector 546 onto the map. Items on the map are checked in the selector.
Pictures 548.
These can be placed on the map to illustrate, highlight and designate the location of items.
Objects 550 are shown as placed on the map.
Shape Tools 552.
Custom shape tools can be created and dragged onto the map.
Drawing Tools 554.

### Module Types

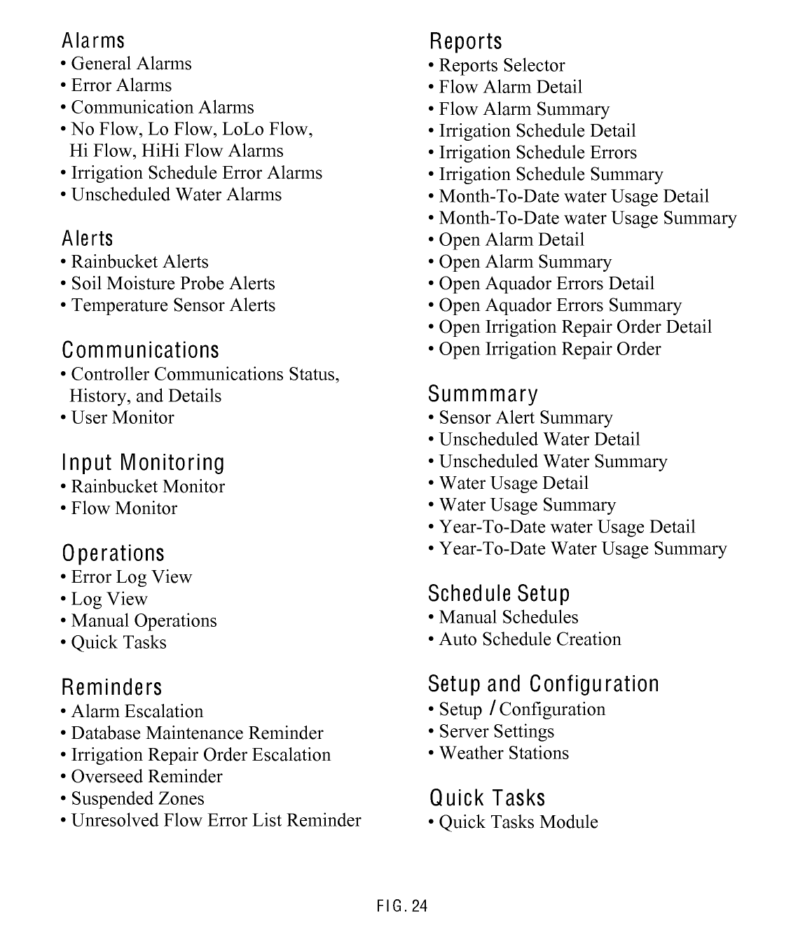

Multiple types of modules 503, shown in FIG. 12, may be used in different embodiments with different applications. FIG. 24 shows an example of modules useful for irrigation.

### Quick Tasks Module

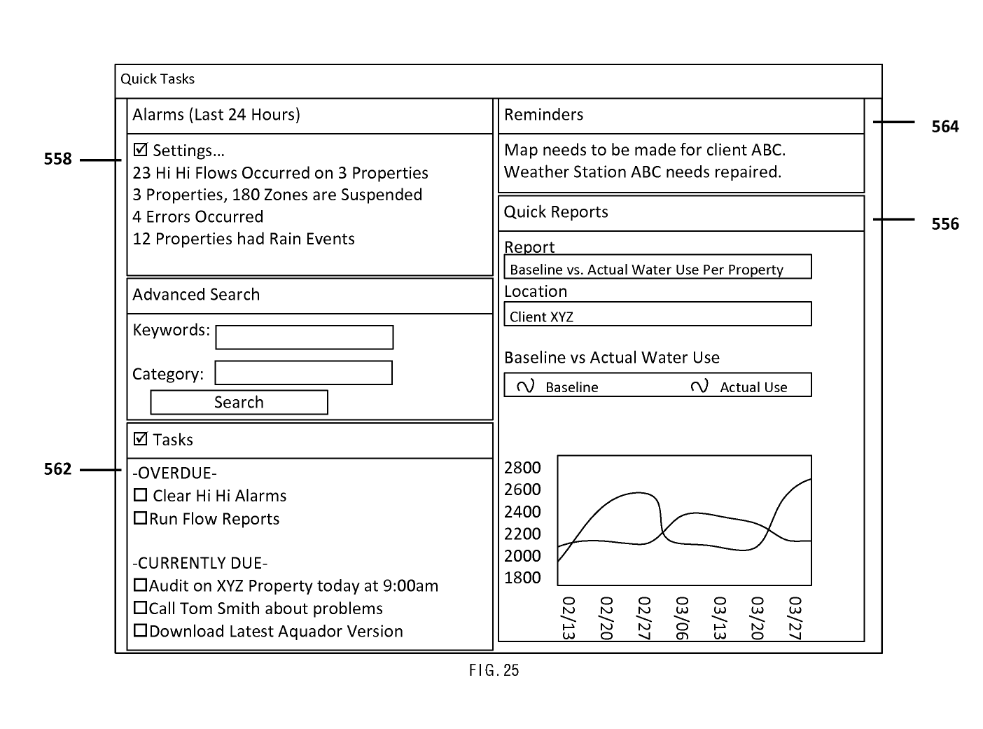

The Quick Tasks Module, shown in FIG. 25, gives the user a “live” overview of the daily operations for which the user is assigned. The module itself is customizable, allowing the user to add, remove and reposition the most important tasks that he or she needs. Each task item in the Quick Task Module is called a “mini module.” In an embodiment, the list of mini modules includes:
Quick Reports 556
A Quick Report 556 is a set of predefined reports that give the user a quick snapshot of how things are going on the property. Some “Quick Reports” are displayed in table form, and others in chart form. Most of these reports are live, meaning that the reports are updated as events occur to reflect real-time data.
Alarms 558.
These provide an overview of alarm conditions that have occurred over a specified period of time. Alarms 558 are also live. The most recent alarm 558 changes always bubble to the top and are highlighted for a user defined period of time. Alarms 558 are Live Linked.
Live linked items, when clicked, take the user to the appropriate action form or module. For example, clicking on “23 Hi Hi Flows Occurred on 3 Properties, 6 Zones” will open a detailed report showing the conditions outlined; whereas clicking on “3 Properties, 180 Zones are Suspended” opens the Manual Operations module showing all the suspended zones, allowing the user to see the reasons for suspension as well as resume the zones.
Search 560.
This finds items using a keyword and category search. This is very useful navigational tool for novice users of the dashboard.
Tasks List 562.
This lists action items that a user needs to complete. Tasks can be created in the Task Module for the user's own needs, and also by supervisors who can send tasks to a user. Tasks are Live Linked.
Reminders 564.
Reminders 564 are like tasks (and may be linked to tasks). Reminders are Live Linked.

### Examples of Use of Irrigation System

### Example 1

### Area Supervisor (AS)

An A.S. is in charge of monitoring the status and condition of clients C1, C2, and C3, plus property P1 of client C8. For this, he must do the following:
Notify clients of any detected leaks;
Send notices to irrigation contractors to make repairs on any valves that are stuck open, or closed;
Determine that the appropriate amounts of water are being applied to each zone.
Watch the total water use for the month, and compare this to historical water use, to gauge and/or alert his boss and/or clients as to potential overages for the month; and
Look for any errors that may have occurred in the system during hours or days when no one is watching the system, and alert the appropriate people.

Monday morning the AS runs a copy of the dashboard 418, shown in FIG. 6, from his office computer 110. He opens the login screen and enters his user name and password. The dashboard 418 loads up, displaying his last saved layout.

To check for any leaks that occurred since Friday, he clicks on the Module Selector icon from the Bubble Bar 514, shown in FIG. 12, and from the Module Selector, highlights and loads the Reports Module.

All newly loaded Modules appear as undocked, separate windows. The AS docks the Report Module to the top of the dashboard 514, where it appears along side his previous modules as a tab. He then selects the Mainline Leaks report.

Next, he selects all his available clients and properties. The AS has been assigned specific rights to C1, C2, C3 and P1; therefore, these are the only clients and properties available to him. He specifies to run the report showing all events since his last run.

The report indicates 3 mainlines have leaked a significant amount of water. To send this report to his clients, he clicks the Send To Clients button, which displays the list of clients and their contact information, gives him a chance to confirm or modify the recipients, add a message to the body of the email and send the report to the appropriate contacts.

Because this is a routine task for this user, AS will add this report to a Report Group called “Monday Reports.” The settings for this report are saved as well.

To complete the remaining tasks, the user selects the appropriate reports and runs each one, also adding them to the “Monday Reports” group.

The following Monday, AS can simply log in and select the “Monday Reports” group and run all his reports in one action.

### Example 2

### Field Assistant Operator (FAO)

A FAO helps people at the irrigation sites, such as clients, property managers, and landscape maintenance field personnel, who call in to perform tasks on the site. The FAO is called numerous times by various users, and she may be asked to:
Operate field valves;
Measure water flow; and
Help callers locate physical entities within their sprawling landscape (such as controllers, zone valves, flow meters).

The FAO has two Dashboard Windows open on her multi-monitor computer system 120, shown in FIG. 6. The dashboard 418 on the left monitor is open to the Manual Operations module docked to the top, with the Log View module docked bottom left, and the Flow Meter Module docked bottom right.

When a user for client C1 calls in to open hydrozone 3 on their property P2, she selects the Manual Operations module, navigates to property P2, highlights the Zone Valve in the list of displayed valves, right-clicks and selects “Open . . . ” from the context menu.

Shortly after processing this command, the dashboard 418 receives and displays the notification that hydrozone 3 opened up. The hydrozone itself changes color on the dashboard 418 to show the new status, and the log view ads a human readable text description row to indicate the action.

In the second Dashboard Monitor, the FAO has the Map Module showing full-screen. When the caller asks her for the location of the Flow Meter, she opens the map, illustrated in FIG. 23, by selecting the appropriate Property from the TreeView Navigator 546, and the specific map from the map list.

The map loads from the server 100, shown in FIG. 6, she highlights the Flow Meter in the list of devices from the object selector, and from the Context Menu commands “Highlight”, which causes the map to zoom and pan the item to the center of the map and flashes it until the user finds and selects the object.

She then tells the caller where to find it based on the map details.

### Advantages of Present Invention

The present invention provides clear advantages over prior techniques.

Centralized Control through Non-Decision Making Controllers

Using non-decision making controllers at irrigation sites and placing irrigation algorithms at the server lever, offers several advantages. The server becomes a virtual information broker for independent dashboards, and its software can also be installed on customer servers for use with other systems. It secures links and distributes information to each independent dashboard, as needed per user, user type, user rights and momentary user needs. Moreover, controllers can be updated efficiently from central locations and could even be mobile, on trucks for example. In addition, the system can be adapted easily for other industries besides irrigation.

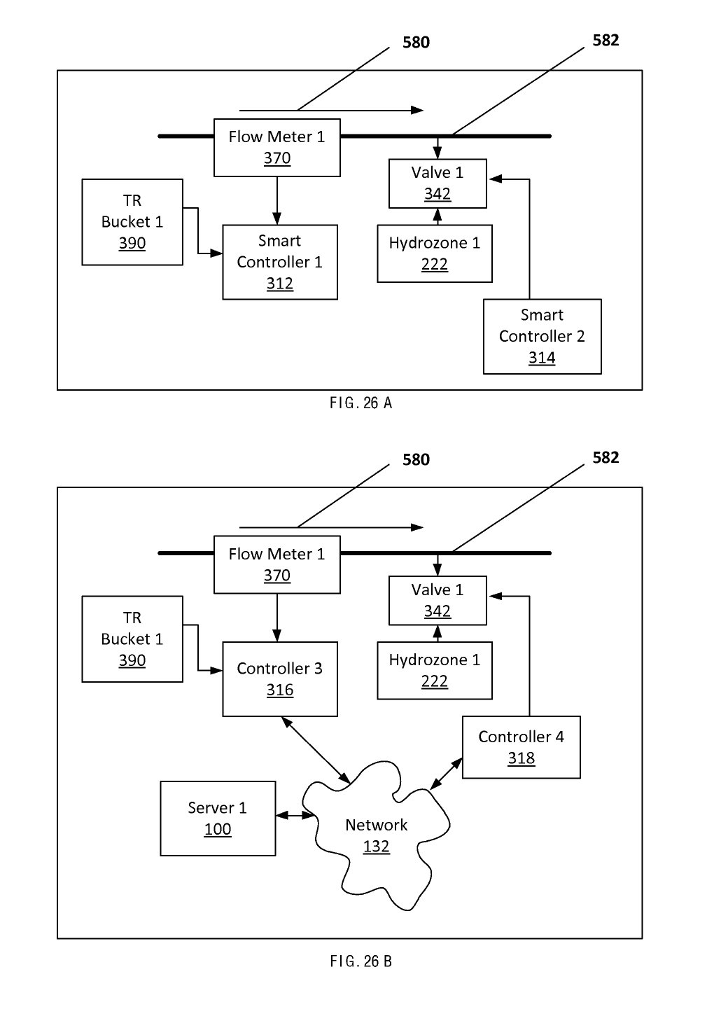

FIG. 26A and FIG. 26B illustrate an important difference between a typical prior centralized technique and the present invention. In the prior technique, shown in FIG. 26A, smart controller 1 312 receives input from TR bucket 1 390 and flow meter 1 370, which monitors the water flow 580 along a mainline 582. Smart controller 2 314 controls the output of valve 1 342 for hydrozone 1 222. Because smart controller 1 312 and smart controller 2 314 are not physically connected, an event that could trigger stopping irrigation through smart controller 2 314 cannot occur.

However, with the present invention, shown in FIG. 26B, controller 3 316 receives input from TR bucket 1 390 and flow meter 1 370, which again monitors the water flow 580 along a mainline 582. Controller 4 318 controls the output of valve 1 342 for hydrozone 1 222. Because controller 3 316 and controller 4 318 can communicate with the same server 1 100 over a network 132, input from controller 3 316 can trigger output events on controller 4 318 through server 1 100.

### Increased Monitoring Capabilities

The dashboard provides effective monitoring of events at irrigation sites. It can automatically sense and stop significant system leaks when they occur by sending commands to close valves. Or it can send alerts to customers who can then stop the leaks. The system can also be used to display data to users through dashboards at multiple locations, so they can make decisions. In addition, by monitoring and managing the soil moisture content percentage before, during and after rain events occur, the system can take full advantage of natural rain events to optimize irrigation. As a result, water savings per property may be well in excess of 50%-70%.

### Description of Embodiment

### Shared Savings Business Model

Another aspect of the invention is a shared savings business model where the vendor provides a system, such as an irrigation system, and the customer only pays the vendor a percentage of the savings obtained by using the system. The savings is typically established by comparing historical usage with current usage. This business model permits the customer to begin realizing savings without budgeting capital expenditure, and it begins saving water or other resources immediately. The model encourages the vendor to design and install systems that are economical, robust, and effective. The model is effective for the vendor because the monitoring and control system is highly effective at producing substantial savings.

### Description of Embodiment

### Environmental Credits Business Model

Another aspect of the invention is the opportunity to rapidly deploy improved control systems to save water for a community. In this example, a first entity such as an oil and gas producer may be depleting a resource such as groundwater. That entity can offset the use of the groundwater by sponsoring a water-savings program for a second entity, for example in exchange for the market value of the resource. In one example, the first entity contracts with a vendor to deploy the vendor's irrigation management systems for the second entity. The vendor installs and monitors the systems and measures the volume of water savings. This volume is then “credited” to the first entity to offset the waste of groundwater. For example, the first entity can utilize the water savings at the second entity as an offset of water overuse on the first entity's own project, or for an environmental stewardship advertisement campaign.

This model is analogous to “carbon credits” which are an accepted way to exchange conservation-related credits among entities.

### Alternate Embodiments

The previous extended description has explained some of the alternate embodiments of the present invention. It will be apparent to those skilled in the art that many other alternate embodiments of the present invention are possible without departing from its broader spirit and scope.

It will also be apparent to those skilled in the art that different embodiments of the present invention may employ a wide range of possible hardware and of software techniques. For example, the communication among computers could take place through any number of links, including wired, wireless, infrared, or radio ones, and through other communication networks beside those cited, including any not yet in existence.

Furthermore, in the previous description the order of processes, their numbered sequences, and their labels are presented for clarity of illustration and not as limitations on the present invention.

What is claimed is:

1-17. (canceled)

18. A computer-based shared savings business method for a vendor to provide an irrigation water management system to a customer, the method comprising
determining the historical irrigation water use for the customer;
the vendor installing, at the vendor's expense, an irrigation water management system for the customer, the water management system including computer-based tracking of customer irrigation water usage;
using the irrigation water management system for a time period;
determining, from the computer-based tracking, the actual irrigation water usage at the entity for the time period;
calculating the cost savings of irrigation water between the actual usage and the historical usage; and
the vendor charging the customer for at least a portion of the cost savings.

19-27. (canceled)
